(19) United States
(12) Patent Application Publication
(10) Pub. No.: US 2025/0334720 A1
(43) Pub. Date: Oct. 30, 2025

(54) LOW-TRANSMITTANCE AND LOW-REFLECTANCE COATED SUBSTRATE AND MANUFACTURING METHOD THEREOF

(71) Applicant: Morrison Opto-Electronics Ltd., Taipei City (TW)

(72) Inventors: Sheng-Wei WANG, Taipei City (TW); Yun-Hui TAI, Taipei City (TW); Tsung-Hsiu WU, Taipei City (TW); Chin-Chen KUO, Taipei City (TW)

(21) Appl. No.: 18/828,039

(22) Filed: Sep. 9, 2024

(30) Foreign Application Priority Data
Apr. 30, 2024 (TW) 113116154

(51) Int. Cl. G02B 1/113; G02B 5/20

(52) U.S. Cl. CPC G02B 1/113; G02B 5/208

(57) ABSTRACT

Disclosed is a coated substrate, comprising: a light-transmissible substrate; an optical film layer, disposed on an upper surface of the light-transmissible substrate to provide a base average reflectance and a base transmittance for light incident to the light-transmissible substrate; and a rough structure layer, formed between the upper surface of the light-transmissible substrate and the optical film layer such that the coated substrate has an adjusted average reflectance and an adjusted transmittance for light incident to the light-transmissible substrate, wherein the base average reflectance is less than 1.5%, the base transmittance is less than 0.1%, the adjusted average reflectance is less than the base average reflectance, and the adjusted transmittance is not greater than the base transmittance.

### FIELD OF THE INVENTION

The present invention relates to an automotive lens, and more particularly relates to a low-transmittance and low-reflectance coated substrate and a manufacturing method thereof.

### BACKGROUND OF THE INVENTION

Nowadays, automotive lenses are widely used in the automotive technology field. On the automotive lenses, a coating is usually applied for protection. A conventional coated substrate 100 for automotive lenses, as shown in FIG. 1, has an optical film 102 coated on a surface of a substrate 101 for automotive lenses such that the coated substrate 100 has the characteristic of low transmittance and low reflectance. However, the reflectance of the conventional coated substrate cannot be achieved to be less than 1%. Therefore, it is sought for a coated substrate having a low reflectance of less than 1%.

### SUMMARY OF THE INVENTION

Accordingly, in view of the above issues, one objective of the present invention is to provide a low-transmittance and low-reflectance coated substrate and a manufacturing method thereof to solve technical problems in a prior art.

In order to overcome the technical problems in the prior art, the present invention provides a coated substrate, comprising: a light-transmissible substrate; an optical film layer, disposed on an upper surface of the light-transmissible substrate to provide a base average reflectance and a base transmittance for light incident to the light-transmissible substrate; and a rough structure layer, formed between the upper surface of the light-transmissible substrate and the optical film layer such that the coated substrate has an adjusted average reflectance and an adjusted transmittance for light incident to the light-transmissible substrate, wherein the base average reflectance is less than 1.5%, the base transmittance is less than 0.1%, the adjusted average reflectance is less than the base average reflectance, and the adjusted transmittance is not greater than the base transmittance.

In one embodiment of the present invention, the coated substrate is provided, wherein the coated substrate has a reflectance of less than 0.4% for light at an incident angle of 0°.

In one embodiment of the present invention, the coated substrate is provided, wherein the coated substrate has a reflectance of less than 0.6% for light at an incident angle of 40°.

In one embodiment of the present invention, the coated substrate is provided, wherein the optical film layer contains titanium and silicon.

In order to overcome the technical problems in the prior art, the present invention further provides a manufacturing method of the coated substrate as mentioned above, comprising: a preparing step of preparing a light-transmissible substrate; a rough structure layer forming step of forming a rough structure layer by performing a roughening process on an upper surface of the light-transmissible substrate; an optical film layer forming step of forming an optical film layer on an upper surface of the rough structure layer to obtain the coated substrate, wherein the optical film layer provides a base average reflectance and a base transmittance for light incident to the light-transmissible substrate, the rough structure layer further enables the coated substrate has an adjusted average reflectance and an adjusted transmittance for light incident to the light-transmissible substrate, the base average reflectance is less than 1.5%, the base transmittance is less than 0.1%, the adjusted average reflectance is less than the base average reflectance, and the adjusted transmittance is not greater than the base transmittance.

In one embodiment of the present invention, the coated substrate is provided, wherein in the rough structure layer forming step, the roughening process is a photolithography process.

In one embodiment of the present invention, the coated substrate is provided, wherein in the rough structure layer forming step, the roughening process includes a photoresist forming step, an exposure step, and a developing step.

In one embodiment of the present invention, the coated substrate is provided, wherein in the optical film layer forming step, the optical film layer contains titanium and silicon.

With the technical means adopted by the present invention, the low-transmittance and low-reflectance coated substrate of the present invention has the adjusted average reflectance less than the base average reflectance and the adjusted transmittance not greater than the base transmittance by forming the rough structure layer between the upper surface of the light-transmissible substrate and the optical film layer. Furthermore, by forming the rough structure layer, the low-transmittance and low-reflectance coated substrate has the reflectance of less than 0.4% for light at an incident angle of 0° and the reflectance of less than 0.6% for light at an incident angle of 40°, thereby realizing the low-transmittance and low-reflectance coated substrate having the reflectance of less than 1% at a large incidence angle. Moreover, with the technical means adopted by the present invention, the manufacturing method of the low-transmittance and low-reflectance coated substrate can manufacture the low-transmittance and low-reflectance coated substrate having the adjusted average reflectance less than the base average reflectance and the adjusted transmittance not greater than the base transmittance.

### BRIEF DESCRIPTION OF THE DRAWINGS

FIG. 1 is a schematic drawing of a conventional coated substrate;

FIG. 2 is a schematic drawing of a low-transmittance and low-reflectance coated substrate according to one embodiment of the present invention;

FIG. 3 is a flow chart of a manufacturing method of a low-transmittance and low-reflectance coated substrate according to one embodiment of the present invention;

FIG. 4 is a schematic drawing of a preparing step of the manufacturing method of the low-transmittance and low-reflectance coated substrate according to the embodiment of the present invention;

FIG. 5 is a schematic drawing of a rough structure layer forming step of the manufacturing method of the low-transmittance and low-reflectance coated substrate according to the embodiment of the present invention;

FIG. 6 is a schematic drawing of an optical film layer forming step of the manufacturing method of the low-transmittance and low-reflectance coated substrate according to the embodiment of the present invention; and

FIG. 7 is a graph showing the transmittance and reflectance of the low-transmittance and low-reflectance coated substrate according to the embodiment of the present invention and a conventional coated substrate.

### DETAILED DESCRIPTION OF THE PREFERRED EMBODIMENTS

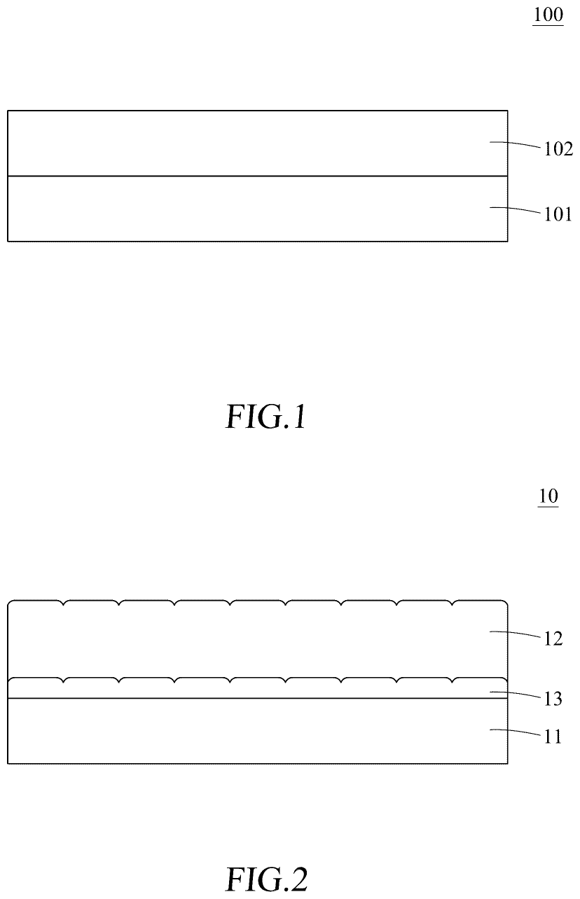

The preferred embodiments of the present invention are described in detail with reference to FIG. 1 to FIG. 7. The description is used for explaining the embodiments of the present invention only, but not for limiting the scope of the claims.

FIG. 2 is a schematic drawing of a low-transmittance and low-reflectance coated substrate according to one embodiment of the present invention. As shown in FIG. 2 the low-transmittance and low-reflectance coated substrate 10 according to one embodiment of the present invention comprises: a light-transmissible substrate 11, an optical film layer 12 and a rough structure layer 13.

Specifically, the light-transmissible substrate 11 is a plate-like element used for protecting the lens while allowing light to pass therethrough. As the light-transmissible substrate 11, a glass substrate, a polycarbonate substrate, or an acrylic substrate may be taken. However, the present invention is not limited to this, and the light-transmissible substrate 11 may be made of any material as long as it can protect the lens, allow light to pass through, and allow the formation of the optical film layer 12 and the rough structure layer 13 on its upper surface.

The optical film layer 12 is disposed on the upper surface of the light-transmissible substrate 11 to provide a base average reflectance and a base transmittance for light incident to the light-transmissible substrate 11 of the low-transmittance and low-reflectance coated substrate 10.

The rough structure layer 13 is formed between the upper surface of the light-transmissible substrate 11 and the optical film layer 12 such that the low-transmittance and low-reflectance coated substrate 10 has an adjusted average reflectance and an adjusted transmittance for light incident to the light-transmissible substrate 11.

Specifically, in the low-transmittance and low-reflectance coated substrate 10, the base average reflectance is less than 1.5%, the base transmittance is less than 0.1%, the adjusted average reflectance is less than the base average reflectance, and the adjusted transmittance is not greater than the base transmittance.

The low-transmittance and low-reflectance coated substrate 10 according to the embodiment of the present invention has the adjusted average reflectance less than the base average reflectance and the adjusted transmittance not greater than the base transmittance by forming the rough structure layer 13 between the upper surface of the light-transmissible substrate 11 and the optical film layer 12.

In detail, according to one embodiment of the present invention, the low-transmittance and low-reflectance coated substrate 10 has a reflectance of less than 0.4% for light at an incident angle of 0°.

Furthermore, according to one embodiment of the present invention, the low-transmittance and low-reflectance coated substrate 10 has a reflectance of less than 0.6% for light at an incident angle of 40°.

By forming the rough structure layer 13, the low-transmittance and low-reflectance coated substrate 10 has the reflectance of less than 0.4% for light at an incident angle of 0° and the reflectance of less than 0.6% for light at an incident angle of 40°, thereby realizing the low-transmittance and low-reflectance coated substrate 10 having the reflectance of less than 1% at a large incidence angle.

Furthermore, in the present embodiment, the optical film layer 12 of the low-transmittance and low-reflectance coated substrate 10 according to the present invention contains titanium and silicon.

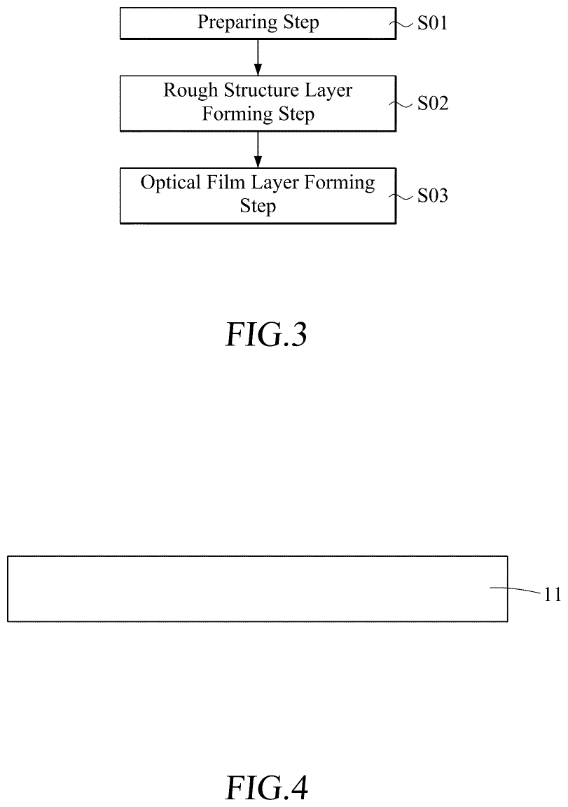

According to FIG. 3 to FIG. 6A, a manufacturing method of a low-transmittance and low-reflectance coated substrate will be described below. FIG. 3 shows a flow chart of the manufacturing method of the low-transmittance and low-reflectance coated substrate according to one embodiment of the present invention. FIG. 4 to FIG. 6 show schematic drawings of a preparing step, a rough structure layer forming step and an optical film layer forming step of the manufacturing method of the low-transmittance and low-reflectance coated substrate according to the embodiment of the present invention.

As shown in FIG. 3, the manufacturing method of the low-transmittance and low-reflectance coated substrate comprises: a preparing step S01, a rough structure layer forming step S02 and an optical film layer forming step S03.

First, as shown in FIG. 3 and FIG. 4, in the preparing step S01, a light-transmissible substrate 11 is prepared.

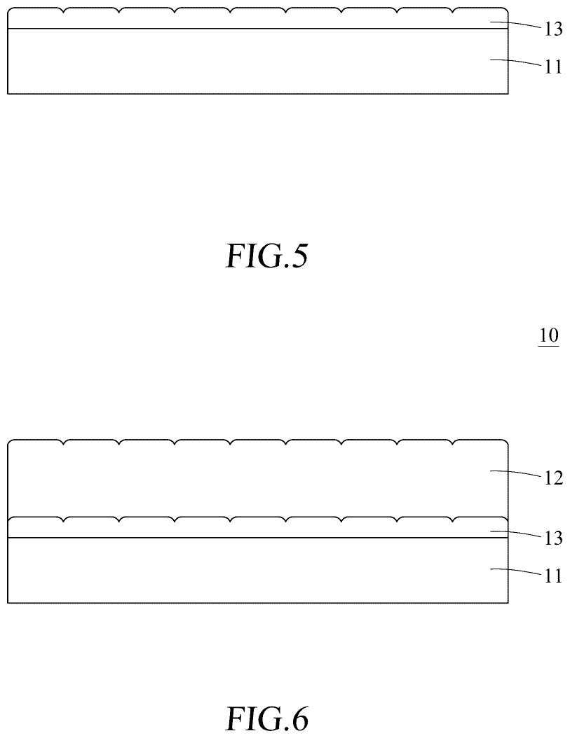

Next, as shown in FIG. 3 and FIG. 5, in the rough structure layer forming step S02, a rough structure layer 12 is formed by performing a roughening process on an upper surface of the light-transmissible substrate 11.

Next, as shown in FIG. 3 and FIG. 6, in the optical film layer forming step S03, an optical film layer 13 is formed on an upper surface of the rough structure layer 12 to obtain a low-transmittance and low-reflectance coated substrate 10.

Specifically, the optical film layer 12 provides a base average reflectance and a base transmittance for light incident to the light-transmissible substrate 11 of the low-transmittance and low-reflectance coated substrate 10, and the rough structure layer 13 further enables the low-transmittance and low-reflectance coated substrate 10 has an adjusted average reflectance and an adjusted transmittance for light incident to the light-transmissible substrate 11, wherein the base average reflectance is less than 1.5%, the base transmittance is less than 0.1%, the adjusted average reflectance is less than the base average reflectance, and the adjusted transmittance is not greater than the base transmittance.

With the manufacturing method of the low-transmittance and low-reflectance coated substrate, the low-transmittance and low-reflectance coated substrate 10 having the adjusted average reflectance less than the base average reflectance and the adjusted transmittance not greater than the base transmittance can be manufactured.

Specifically, in the manufacturing method of the low-transmittance and low-reflectance coated substrate according to the present invention, in the rough structure layer forming step S02, the roughening process is a photolithography process. Furthermore, the roughening process includes a photoresist forming step, an exposure step, and a developing step.

Needless to say, in the present invention, the roughening process of the rough structure layer forming step S02 is not limited to the photolithography process, and the roughening process of the rough structure layer forming step S02 may also be, for example, a laser process or an etching process as long as the rough structure layer can be formed between the upper surface of the light-transmissible substrate 11 and the optical film layer 13.

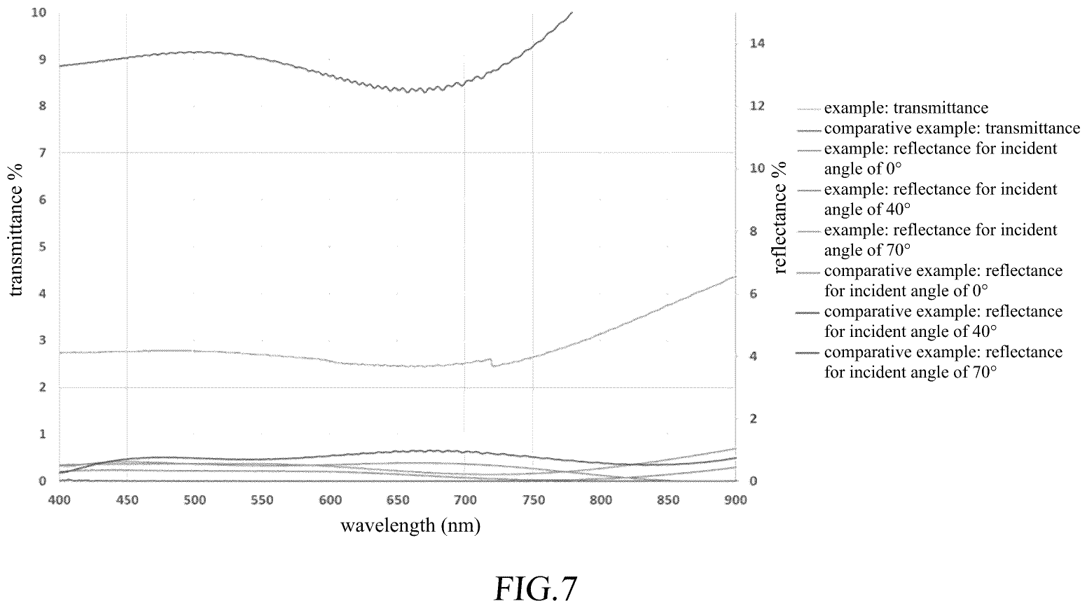

According to FIG. 7, the transmittance and reflectance of the low-transmittance and low-reflectance coated substrate according to the present invention and a conventional coated substrate will be described below. FIG. 7 is a graph showing the transmittance and reflectance of the low-transmittance and low-reflectance coated substrate according to the present invention and the conventional coated substrate.

The graph of the transmittance and reflectance shown in FIG. 7 shows the result of measuring the transmittance and reflectance of the low-transmittance and low-reflectance coated substrate 10 according to the present invention and the conventional coated substrate 100 by a commercially available spectrophotometer (Agilent CARY 6000i), wherein the low-transmittance and low-reflectance coated substrate 10 according to the present invention shown in FIG. 2 is used as an example, while the conventional coated substrate 100 as shown in FIG. 1 is used a comparative example.

As shown in FIG. 7, within the wavelength range of incident light from 400 nm to 900 nm, the transmittance of the conventional coated substrate 100 in the comparative example and the transmittance of the low-transmittance and low-reflectance coated substrate 10 according to the present invention are both less than 0.1%. In other words, the low-transmittance and low-reflectance coated substrate 10 according to the present invention has the same characteristic of low transmittance as the conventional coated substrate 100.

Furthermore, from the measurement results of the reflectance for light at an incident angle of 0°, it is found that the reflectance of the conventional coated substrate 100 in the comparative example is approximately 0.5%. Compared to the comparative example, the reflectance of the low-transmittance and low-reflectance coated substrate 10 according to the present invention is approximately 0.2%, which is lower than that of the conventional coated substrate 100 in the comparative example.

Furthermore, from the measurement results of the reflectance for light at an incident angle of 40°, it is found that the reflectance of the conventional coated substrate 100 in the comparative example is approximately 0.8%. Compared to the comparative example, the reflectance of the low-transmittance and low-reflectance coated substrate 10 according to the present invention is approximately 0.4%, which is significantly lower than that of the conventional coated substrate 100 in the comparative example.

Furthermore, from the measurement results of the reflectance for light at an incident angle of 70°, it is found that the reflectance of the conventional coated substrate 100 in the comparative example exceeds 12.0%. Compared to the comparative example, the reflectance of the low-transmittance and low-reflectance coated substrate 10 according to the embodiment of the present invention is approximately 4.0%, which is only one-third of the reflectance of the conventional coated substrate 100 in the comparative example.

With the technical means adopted by the present invention, the low-transmittance and low-reflectance coated substrate 10 of the present invention has the adjusted average reflectance less than the base average reflectance and the adjusted transmittance not greater than the base transmittance by forming the rough structure layer 13 between the upper surface of the light-transmissible substrate 11 and the optical film layer 12.

Furthermore, by forming the rough structure layer 13, the low-transmittance and low-reflectance coated substrate 10 has the reflectance of less than 0.4% for light at an incident angle of 0° and the reflectance of less than 0.6% for light at an incident angle of 40°, thereby realizing the low-transmittance and low-reflectance coated substrate 10 having the reflectance of less than 1% at a large incidence angle.

Moreover, with the technical means adopted by the present invention, the manufacturing method of the low-transmittance and low-reflectance coated substrate can manufacture the low-transmittance and low-reflectance coated substrate 10 having the adjusted average reflectance less than the base average reflectance and the adjusted transmittance not greater than the base transmittance.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A coated substrate, comprising:
a light-transmissible substrate;
an optical film layer, disposed on an upper surface of the light-transmissible substrate to provide a base average reflectance and a base transmittance for light incident to the light-transmissible substrate; and
a rough structure layer, formed between the upper surface of the light-transmissible substrate and the optical film layer such that the coated substrate has an adjusted average reflectance and an adjusted transmittance for light incident to the light-transmissible substrate,
wherein
the base average reflectance is less than 1.5%,
the base transmittance is less than 0.1%,
the adjusted average reflectance is less than the base average reflectance, and
the adjusted transmittance is not greater than the base transmittance.

2. The coated substrate as claimed in claim 1, wherein the coated substrate has a reflectance of less than 0.4% for light at an incident angle of 0°.

3. The coated substrate as claimed in claim 1, wherein the coated substrate has a reflectance of less than 0.6% for light at an incident angle of 40°.

4. The coated substrate as claimed in claim 1, wherein the optical film layer contains titanium and silicon.

5. A manufacturing method of the coated substrate as claimed in claim 1, comprising:
a preparing step of preparing a light-transmissible substrate;
a rough structure layer forming step of forming a rough structure layer by performing a roughening process on an upper surface of the light-transmissible substrate;
an optical film layer forming step of forming an optical film layer on an upper surface of the rough structure layer to obtain the coated substrate,
wherein
the optical film layer provides a base average reflectance and a base transmittance for light incident to the light-transmissible substrate,
the rough structure layer further enables the coated substrate has an adjusted average reflectance and an adjusted transmittance for light incident to the light-transmissible substrate,
the base average reflectance is less than 1.5%,
the base transmittance is less than 0.1%,
the adjusted average reflectance is less than the base average reflectance, and
adjusted transmittance is not greater than the base transmittance.

6. The manufacturing method as claimed in claim 5, wherein in the rough structure layer forming step, the roughening process is a photolithography process.

7. The manufacturing method as claimed in claim 6, wherein in the rough structure layer forming step, the roughening process includes a photoresist forming step, an exposure step, and a developing step.

8. The manufacturing method as claimed in claim 5, wherein in the optical film layer forming step, the optical film layer contains titanium and silicon.
